(19) United States
(12) Patent Application Publication
(10) Pub. No.: US 2009/0080885 A1
(43) Pub. Date: Mar. 26, 2009

(54) SCHEDULING METHOD AND SYSTEM FOR OPTICAL BURST SWITCHED NETWORKS

(75) Inventors: Pronita Mehrotra, Redmond, WA (US); Dan Stevenson, Chapel Hill, NC (US); Mark Cassada, Hillsborough, NC (US); Wayne Dettloff, Cary, NC (US)

Correspondence Address: OBLON, SPIVAK, MCCLELLAND MAIER & NEUSTADT, P.C., 1940 DUKE STREET, ALEXANDRIA, VA, 22314, US

(73) Assignee: Research Triangel Institute, Research Triangle Park, NC (US)

(21) Appl. No.: 11/915,636

(22) PCT Filed: May 27, 2005
(86) PCT No.: PCT/US2005/018658

§ 371 Date: Oct. 6, 2008

(51) Int. Cl. H04J 14/02; H04J 3/16

(52) U.S. Cl. 398/48; 398/52

(57) ABSTRACT

An optical network scheduling device (10) including a plurality of schedulers (16) each corresponding to a respective channel in the optical burst switch network and configured to maintain a transmission schedule for the respective channel; and a controller (12) configured to receive a burst transmission request and to select at least one of the schedulers as a selected scheduler schedule a burst transmission.

### BACKGROUND OF THE INVENTION

1. Field of the Invention

The present disclosure relates to optical communication networks and, more particularly, to an Optical Burst-Switching (OBS) network.

2. Discussion of the Background

In addition to the choice of a network's medium and transmission format, network performance is affected by the choice of switching paradigm. For optical networks, Optical Burst Switching (OBS) offers several known advantages. For instance, by eliminating buffering and switching variable size bursts on the fly, OBS enhances network utilization and reduces data latency. Unfortunately, while OBS has achieved some favor with the telecommunications industry, such is not the case for any particular scheduling protocol.

### SUMMARY OF THE INVENTION

Accordingly, one object of the present invention is to provide an optical network employing an OBS scheduling architecture that accommodates multiple scheduling protocols.

Various of these and other objects can be provided in the non-limiting embodiments of the present invention.

In one non-limiting embodiment, a scheduling device for an optical burst switch network can include: a plurality of schedulers each corresponding to a respective channel in the optical burst switch network and configured to maintain a transmission schedule for the respective channel; and a controller configured to receive a burst transmission request and to select at least one of the schedulers as a selected scheduler to schedule a burst transmission.

In another non-limiting embodiment, a scheduling method of managing transmissions of a data burst in an optical burst switch network having a plurality of channels can include: receiving a burst request; generating an inquiry to a plurality of schedulers corresponding to the respective channels, each scheduler configured to maintain a transmission schedule for the respective channel; searching the transmission schedules at each of the schedulers to determine vacant slots for each channel; and selecting at least one of the plurality of schedulers to schedule the burst based at least in part on the reported vacant transmission slots.

In another non-limiting embodiment, an Optical Burst Switch (OBS) network can include: an optical bus; network terminal devices coupled to the optical bus; a plurality of network adapters in optical communication with the optical bus and in communication with the network terminal devices, each of the network adapters configured to provide bi-directional transmission of burst transmissions between the optical bus and the network terminal devices; and an optical bus controller in optical communication with the optical bus and configured to establish signal communications between at least two of the network adapters based on a request initiated by one of the at least two of the network adapters.

In another non-limiting embodiment, an optical signal bus for use in an Optical Burst Switch (OBS) network can include: a plurality of optical filters each including an input configured to receive an optical signal, a first output configured to transmit a control channel signal to an optical bus controller, and a second output configured to transmit a data signal on an individual wavelength range; a signal coupling device including a plurality of inputs in optical communication with the second output of each of the plurality of optical filters, and a plurality of outputs configured to transmit in respective wavelength ranges a combined data signal from the plurality of inputs; and a plurality of optical couplers each including a first input configured to receive the control channel signal initiated by the optical bus controller, a second input configured to receive the combined data signal from the signal coupling device, and an output configured to transmit an output optical signal.

In another non-limiting embodiment, an optical bus network adapter for use in an Optical Burst Switch (OBS) network can include: an optical filter including an input configured to receive an inputted optical signal, a first output configured to output a data signal, and a second output configured to transmit a control signal; a data channel receiver including an input configured to receive the data signal from the optical filter and an output configured to transmit the data signal; a control channel receiver including an input configured to receive the control signal from the optical filter and an output configured to transmit the data signal; a physical layer interface including a first input configured to receive the control signal from the control channel receiver, a second input configured to receive the data signal from the data channel receiver, a first output configured to transmit the control signal, and a second output configured to transmit the data signal; a control message processor including a first input configured to receive the control signal from the physical layer interface and an output configured to transmit a control message, the control message processor being in communication with an adapter control processor and a buffer memory and configured to determine at least one control criterion; and a backplane interface including a first input configured to receive the data signal from the physical layer interface, a second input configured to receive the control message from the control message processor, and an output configured to transmit a signal including the data signal and the control message.

In another non-limiting embodiment, an optical bus controller implemented in an Optical Burst Switch (OBS) network can include: a plurality of optical-to-electrical converters each including an input configured to receive an optical signal and an output configured to transmit an electrical signal; a plurality of ingress message engines each including an input configured to receive the output of one of the optical-to-electrical converters, to parse the output of the one of the optical-to-electrical converters, and to obtain current state and protocol responses; an address resolution table configured to communicate with the plurality of ingress message engines to provide the ingress message engines with forwarding information; a channel arbitration device configured to communicate with the plurality of ingress engines and to determine a forwarding schedule based on inputs from the ingress engines and the address resolution table; a plurality of egress message engines each including an input configured to receive communication from the channel arbitration device and an output configured to transmit scheduling data; and a plurality of electrical-to-optical converters each including an input configured to receive data from the egress engines and an output configured to transmit data to the optical signal bus.

In another non-limiting embodiment, an Optical Burst Switch (OBS) network, comprising: an optical signal bus including a signal coupling device; a plurality of network adapters in optical communication with the optical signal bus and in network communication with network terminal devices, wherein each of the network adapters is coupled to a respective terminal equipment and includes a tunable receiver, a transmitter, and a control device so as to perform bi-directional movement of data signals as bursts between the terminal equipment and the OBS network system; and an optical bus controller in optical communication with the optical signal bus and configured to process signals from the optical signal bus to establish communications between a requested network adapter and a requesting network adapter based on a predetermined communication protocol, said optical bus controller configured to implement a just-in-time signaling protocol to signal one of the network adapters coupled to the network to indicate that burst communications are forthcoming.

In another non-limiting embodiment, a method for transparent data transmission in an optical network including a plurality of nodes can include: providing an optically inclusive network configured to schedule optical burst switching of data bursts; transmitting a signaling message from a node to set-up an optical path for a subsequent data transmission message; performing electro-optic conversion of the signaling message; and processing the converted signaling message at one node in the network.

In another non-limiting embodiment, a method for single wavelength data transmission in a network can include: providing an optical burst switch network configured to schedule optical burst switching of data bursts; providing a plurality of network adapters within the optical burst switch network, each of the plurality of network adapters having respective wavelengths for optical data transmission; transmitting data from one of the plurality of network adapters on the respective wavelengths associated with the one of the network adapter; and electronically tuning the one of the plurality of network adapters to transmit a wavelength of another network adapter for receiving data transmissions.

In another non-limiting embodiment, a method for memory access in an optical burst switch network can include: providing an optical burst switch network configured to schedule optical burst switching of data bursts; generating, at one of the network nodes, a setup message that identifies a memory within a destination address field; transmitting, from the one of the network nodes, the setup message to another network node associated with the memory; receiving the setup message at the another network node associated with the memory and parsing the setup message; determining whether the memory identified by the setup message is currently accessible; and accessing the memory in response to a result of the determining step indicating that the memory is accessible.

In another non-limiting embodiment, a method for hierarchical addressing in an optical burst switch network can include: assigning, at a first administrative entity, a first address record of a discretionary length; and assigning, at an (n+1)th administrative entity, an nth address record of a discretionary length.

It is to be understood that both the foregoing general description of the invention and the following detailed description of the invention are exemplary, but are not restrictive of the invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, in which like reference numerals refer to identical or corresponding parts throughout the several views, and in which:

FIG. 1 shows architecture for implementing a scheduler that can handle JIT, JET and Horizon, according to one embodiment of the invention;

FIG. 2 is a block diagram of an exemplary OBS LAN, according to one embodiment of the invention;

FIG. 3 is a signaling scheme diagram for JIT signaling implemented in conjunction with an exemplary OBS WAN, according to one embodiment of the invention;

FIG. 4 is a flowchart showing an exemplary method for memory access in an OBS network implementing JIT signaling, according to one embodiment of the invention;

FIG. 5 is a block diagram of an exemplary optical bus switch for use in conjunction with JIT signaling, according to one embodiment of the invention;

FIG. 6A depicts a flow diagram for optical burst switching, according to one embodiment of the invention;

FIG. 6B depicts one exemplary hardware implementation to implement the flow diagram of FIG. 6A, according to one embodiment of the invention;

FIG. 7 depicts a flowchart depiction an exemplary method for unified global addressing in an OBS LAN implementing JIT, according to one embodiment of the invention;

FIG. 8 is a block diagram depicting an exemplary optical network adapter using the JIT, JET or Horizon protocols, according to one embodiment of the invention; and

FIG. 9 is a block diagram depicting an exemplary optical bus (or switch) signal controller using the JIT, JET or Horizon protocols, according to one embodiment of the invention.

### DETAILED DESCRIPTION OF THE EMBODIMENTS

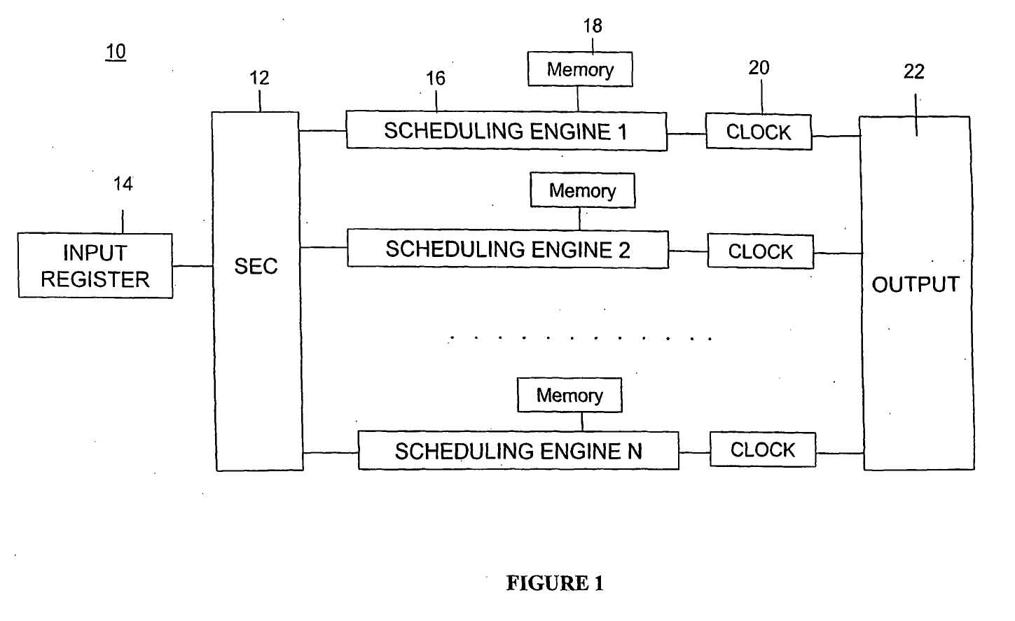

Referring now to the drawings, wherein like reference numerals designate identical or corresponding parts throughout the several views, FIG. 1 shows one architecture according to the present invention for implementing a scheduler that can handle JIT, JET and Horizon. The scheduler 10 can include an SE controller 12 which takes burst requests from the input first-in first-out (FIFO) register 14. The scheduler 10 then passes these requests to one or more scheduling engines (SEs) 16 to find an appropriate slot where the burst request can be accommodated. The scheduling engines 16 can maintain a database of already scheduled bursts in the plurality of sorted link lists. The database can be stored in memories 18 associated with each scheduling engine 16. After searching the database for available slots, the scheduling engines 16 return the results to the SE controller 12 which selects one of the channels for scheduling the burst (based on a programmable strategy like min-SV, min-EV, etc). The SE controller 12 then informs the chosen scheduling engine 16 of its decision, and the scheduling engine 16 adds the entry to its database (e.g., memory 18). The scheduling engines 16 can also output ahead of the line entries, which are compared against a global clock 20 and are used in constructing the output port register 22. The output port register 22 can carry information about which output port is connected to which input port and is used by the switch configurator (not shown in FIG. 1).

The architecture is fairly simple to implement in hardware and can achieve high throughput by exploiting parallelism. Multiple scheduling engines 16 (one for each channel/wavelength) can run in parallel to search for voids in existing schedules. The schedules can store only the burst start and end times along with the port information and not the void times. According to the present invention, one advantage of having separate scheduling engines for each channel is that not all switches will not be required to have full wavelength conversion capability. In such a case, the SE controller 12 may request one, all or, a few engines 16 (depending for example on whether the switch can support no, full or limited wavelength conversion. The number of scheduling engines need not be extensive. For a system running data at 160 Gbps in each channel, no more than 32 channels in the system are expected. Since the scheduling engine 16 performs very simple functions, like searching through a linked list and adding/deleting entries in the linked list, the state machine associated with the engines do not consume a large amount of on-chip real estate.

In terms of latency, the architecture above for the scheduler 10 can perform suitably since the number of memory accesses is quite small. Inserting an entry requires searching through the list (only read operations) followed by a few writes to update appropriate pointers. Entries are only deleted from the head of line (when the entries have been processed) which requires only 1-2 write operations. Since the head of line entries are available without any extra overhead, the switch configuration impact on the scheduling operations will be reduced.

To further improve performance, a pointer to the first and last entry in the linked list can be stored in fast registers. This can speed up all three JIT, JET, and Horizon algorithms but is preferred (but not necessary) for JIT and Horizon, which only need to check the first and the last entry, respectively.

The architecture above for the scheduler 10 can in one embodiment of the present invention accommodate fiber delay lines (FDLs), which increase the offset time by a fixed value. As each scheduling engine searches through the linked list, the scheduling engine can start with the lowest offset value (no FDL). If the scheduling engine reaches an entry whose starting time is less than the requested starting time, the scheduling engine switches to the next higher offset value for the remainder of the list. Therefore, a single traversal of the linked list can be sufficient to check for multiple FDL values.

The present invention may also be applied to a variety of networks, such as but not limited to local area networks (LAN) and wide area networks (WAN). One skilled in the art will recognize that various networks and scheduling protocols may be used in conjunction with the present invention; and further recognize that the present invention may be practice with such other networks and scheduling protocols without undue experimentation. In the following description, non-limiting embodiments of the invention are explained with reference to an OBS LAN implementing JIT.

JIT protocols allow a switching network to deliver and switch data in variable-sized parcels and to reduce the need of permanent or semi-permanent circuits. Burst switching does not require buffering inside the network. Rather, switching of variable-sized bursts can be performed on the fly by using a reservation mechanism. Intermediate switches are only configured for a brief period of time, just enough to pass the burst, and are available to switch other bursts immediately after. The main difference from the packet switching paradigm is the lack of buffering and the much wider range of burst lengths, from very short (i.e., “packets”), to very long (i.e., “circuits”).

An OBS LAN is agnostic with respect to signal type and format, such that the network can carry a wide variety of analog and digital formats concurrently. The OBS LAN utilizes multiple wavelengths capable of being transported within optical fibers. The fiber contains multiple data paths within a single fiber connection. The OBS LAN allows for IP, iSCSI, and other protocols to be transported over these wavelengths to individually addressable Network Adapters (NA) or broadcast to any number of Network Adapters. The network adapters provide the interface between the network and the network terminal equipment, such as telephones, computers, servers, legacy network interfaces and the like. In addition, the network adapters provide hardwired control logic that allow for bi-directional movement of data signals as bursts between the terminal equipment and the network and data signal buffers that provide timing to transmission and receipt of data signals. The network adapters also provide logic to support upper layer functions, including vector mapped direct memory access (DMA) and wire speed forward error correction (FEC), and a network interface that supports the user network signaling function while providing for a separate optical channel for the data signal transmit and receive function. The OBS LAN architecture supports both asynchronous single bursts with a holding time shorter than the diameter of the network, and switched optical paths with a holding time longer that the diameter of the network. The architecture provides out-of-band signaling on a single channel. The signaling channel undergoes electro-optical conversions at each node to make signaling information available to intermediate switches. In the OBS LAN architecture, data is transparent to the intermediate network entities, i.e., no electro-optical conversion takes place at intermediate nodes, such as hubs or passive star couplers (PSCs), and no assumptions are made about data rate or signal modulation. The architecture is such that most processing tasks are supported only at the edge nodes, with the core switches, hub and/or PSCs being kept simple. In addition, simplicity of the architecture is further achieved by not providing for global time synchronization can be provided between nodes.

JIT signaling refers to information transfers as bursts. A burst length is determined in terms of time and may range from a few nanoseconds to hours or days. JIT also makes no assumptions about the information format within a burst, which may be analog or digital. Furthermore, no assumption is made about the modulation method, or the information density (bit rate or bandwidth). In a network implementing Just-In-Time (JIT) signaling protocol, signaling messages are sent just ahead of the data to inform the intermediate switches. The common thread is the elimination of the round-trip waiting time before the information is transmitted. In the JIT approach, also referred to as the tell-and-go approach, the switching elements inside the switches of the network are configured for an incoming burst as soon as the first received signaling message announcing that burst is received.

In conjunction with the OBS LAN architecture, JIT signaling is performed out-of-band with the data being transparent to the intermediate network entities. This transparency means that no electro-optical conversion is done in intermediate nodes, such as passive star coupler (PSC), hub or switch, and no assumptions need to be made at the nodes concerning data rate or modulation methods. In a JIT implemented network, signaling messages are processed by all the intermediate nodes and, as such, electro-optical conversion is performed in the signaling message. Optical communication is conducted such that a single high-capacity signaling channel/wavelength is assigned per fiber. The basic assumption of the architecture is that data, aggregated in bursts, can be transferred from one point to the other by setting up the optical path just ahead of the data arrival. This assumption can be achieved by sending a signaling message ahead of the data to set up the optical communication path. Once the communication of data transfer is completed, the connection is timed out.

Basic switch architecture presumes the existence of a number of input and output ports, each carrying multiple wavelengths. In the invention, a separate wavelength on each port can be dedicated to carrying the JIT signaling protocol, or any wavelength on an incoming port can be switched to either the same wavelength on any outgoing port (no wavelength conversion) or any wavelength on any outgoing port (partial or total wavelength conversion). Switching time is presumed to be in the sub-microsecond range. In this architecture of the invention, a signaling message attempting to setup a path for a burst to travel from one end point to the other preferably informs all intermediate switches or components of the WAN of the arrival of the burst to allow them to set up their mirror configuration to channel the data on one of the data wavelengths. It also can optionally provide the duration of the burst. Typically, each switch in the network will be configured with a scheduler, which will be able to keep track of switching configurations, such as wavelength utilization, and assign them on time to allow the data to pass between the respected nodes.

### Hardware Architecture

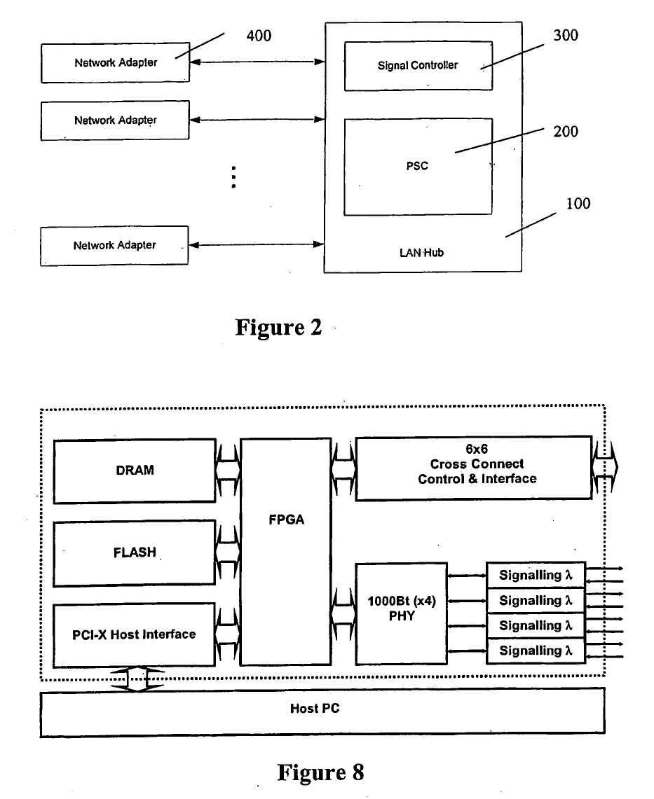

FIG. 2 depicts an exemplary OBS LAN that implements JIT signaling protocol. The network is characterized as being folded and a fully duplexed network. The OBS LAN 100 includes an optical signal bus 200, an optical bus controller 300 and a plurality of network adapters 400. Collectively, the optical bus controller 300 and the optical signal bus 200 are referred to as a hub. In addition, the optical signal bus 200 may be in network communication with one or more optical network interface devices 500, which are arranged outside the OBS LAN 100 and provide network interfaces to external networks.

The optical signal bus 200 is in network communication with the optical bus controller 300 and the plurality of network adapters 400. The network adapters 400 provide network connectivity to terminal equipment, such as server systems, telephones, computers, legacy network interfaces and the like. Fiber pairs, consisting of a transmit and receive fiber, interconnect the plurality of network adapters 400 with the optical signal bus 200. Each fiber in the pair carries two optical signals: (1) a digital control channel configured to transmit and/or receive control signals, and (2) a data channel configured to transmit and/or receive data from one node within the network to another. The control channels in the system all use the same wavelength and provide a dedicated path between each network adapter 400 and the optical bus controller 300. Each network adapter 400 has a unique and dedicated wavelength that it uses to transmit over the data channel. Each adapter's receiver is capable of rapidly electronically tuning to the transmit wavelength of another adapter's transmitter with which it wishes to communicate, or vice-versa. The optical signal bus 200 distributes the optical signal from a transmitting adapter to all adapters connected to the bus 200. The optical bus controller 300 provides a contention resolution protocol for use of the adapter's receive channel. Since each adapter has a unique transmit wavelength, a plurality of adapters may simultaneously use the bus 200, provided that each transmitter seeks a different destination.

(1) Optical Signal Bus

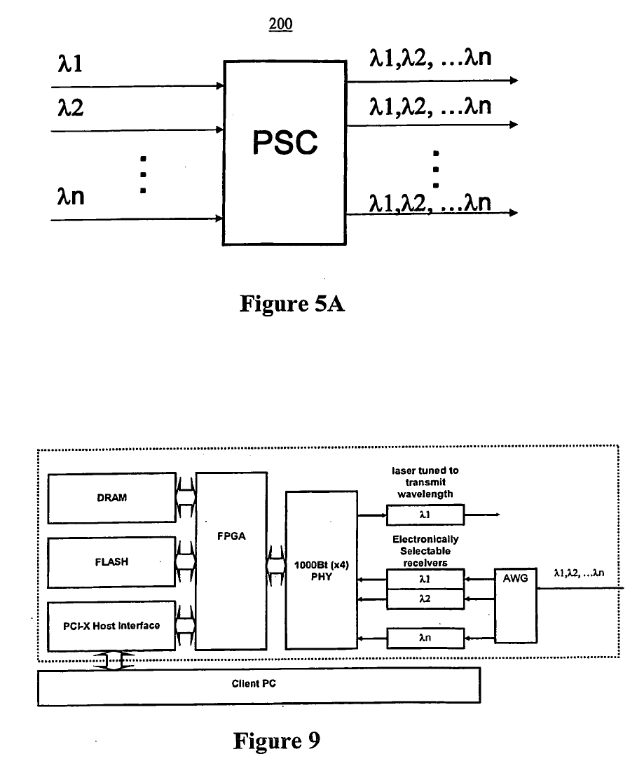

The optical signal bus 200 is characterized as being an unfolded, fully-duplexed network. The optical signal bus 200 may include a star coupler (which is known in the art and shown in FIG. 5A), a plurality of optical filters, and a plurality of optical couplers. An NIC (Network Interface Card) that couples to the OBS LAN 100 generates and processes signaling messages and maintains states. Data is passed to the host with status information.

The plurality of optical filters and optical couplers are in a one-to-one relationship with corresponding network adapters 400 (not shown in FIG. 2). Fibers provide network connectivity between transmitters of the plurality of network adapter 400 (not shown in FIG. 2) and the plurality of optical filters. The plurality of optical filters serve to split out the control channel, i.e., the signaling channel, which is a dedicated wavelength, from the adapter transmit signal, and pass the control channel to the optical bus controller 300 (not shown in FIG. 2) via control channel transmit fibers. In addition, the plurality of optical filters split out the data signal portion of the adapter transmit signal and pass the data signal portion to the star coupler 210 via fibers.

The star coupler 210 combines the data signals being transmitted from the plurality of network adapters 400, each data signal being transmitted on a separate wavelength. Once the data signals are combined, the star coupler 400 splits the combined signal and distributes the combined signal to each of the plurality of optical couplers via fibers. The plurality of optical couplers serve to combine the output control channel signal that is transmitted from the optical bus controller 300 via fibers and the corresponding data channel signal onto a fiber, which is connected to the receiver of one of the plurality of network adapters 400.

The star coupler 210 may be a passive device. For example, if eight (8) or fewer network adapters 400 are used in the network, limiting the number of channels used to eight (8) or fewer, the star coupler 210 may be a passive device. If more network adapters 400 and thus more channels are used, then optical amplification may be used in the star coupler 210 to overcome losses in the signal strength due to splitting and the like.

(2) Network Adapters

The network adapters 400 provide the interface between the network and the network terminal equipment, such as telephones, computers, servers, legacy network interfaces and the like, that couple to the OBS LAN 100. In addition, the network adapters 400 provide hardwired control logic that allows bi-directional movement of data signals as bursts between the terminal equipment and the network and data signal buffers that provide timing for transmission and receipt of data signals. The network adapters 400 also provide logic to support upper layer functions, including vector mapped direct memory access (DMA) and wire speed, forward error correction (FEC), and a network interface that supports the user network signaling function while providing for a separate optical channel for the data signal transmit and receive function.

The network adapter 400 can include the control channel transmitter and receiver and a data channel transmitter and receiver. On the transmit side, an optical coupler combines the control channel signal with the data channel signal, and then sends the combined signal on to an output fiber. On the receive side, an optical filter separates the control channel signal from the data channel signal received from an input fiber.

The control channel and data channel receivers may be tunable receivers. For example, the tunable receiver may comprise a wavelength filter device, which outputs to an array of dWDM optical receivers individually tuned to a fixed ITU (International Telecommunication Unit) wavelength. The control channel and data channel transmitters may be tunable transmitters. For example, the transmit laser may be tuned to a fixed wavelength. Alternatively, large scale networked tunable lasers may be used to manage data flow.

The control channel transmitter and receiver 410 controls the tuning of transmission and receipt of communications, e.g., controls the tuning and receipt via Just-In-Time user-to-network protocol. The control channel is provided via an optical path and may employ a framing structure. A coding scheme that ensures DC balance of the bit stream is used to convert the data bits into frames. A preamble at the beginning of the frame is used for frame synchronization at the receiver end. For example, a 64/66B or 8/10B coding scheme may be used to convert the data bits into frames. The 64/66B scheme offers lower bandwidth overhead. To maintain link synchronization, idle patterns may be transmitted from the control channel to the optical signal bus 200 when data is not being sent. Additionally, data octets may be scrambled prior to transmission using a known scrambling scheme.

The control channel may operate at a frequency greater than about 500 MHz to minimize signal throughput delay and be transported via a separate optical fiber or as a dedicated ITU dWDM wavelength within the data path fiber. When being transported via a wavelength within the data path fiber, the control channel is preferably de-multiplexed and undergoes optical to electric conversion at the input and output port interfaces of the hub.

In operation, once the network adapters 400 are connected to the OBS LAN 100 optical signal bus 200, the network adapters 400 will frame up to the bus 200 and then assert a node present packet over the control channel. The optical signal bus 200 verifies the link and assigns an address to the new node. The network adapter 400 uses this address for all further communications. A conventional addressing scheme utilizing hierarchical node addressing with variable address length may be employed.

The control channel transmitter and receiver and the data channel transmitter and receiver can be in communication with the physical layer (PHY) interface. The physical layer interface can provide the electrical and mechanical interconnection between the data communication equipment (DCE) and the data terminal equipment (DTE). The PHY interface 450 includes a series of modules that implement the optical transmitters and receivers.

Data received from the data channel transmitter and receiver can be passed directly to the electronic backplane interface via the physical layer interface. The control channel transmitter and receiver are in communication with the control message processor via the physical layer interface. The control processor implements the predetermined OBS LAN protocol, which may be the Just-In-Time (JIT) protocol or another protocol capable of OBS communication. The control message processor is in communication with the adapter control processor and buffer memory, which controls the timing of transmission and receipt of OBS communications. The buffer memory can queue the data requests.

Forward Error Correction (FEC) may be implemented in the network adapters 400 to minimize retransmission of data bursts when bit errors are detected in the network and when bursts are lost due to blocking in the core network. FEC may be less useful in chip-to-chip and board-to-board communication LAN or WAN environments in which the Bit Error Rate (BER) becomes high.

(4) Optical Bus Controller

The bus controller 300 utilizes hardware protocol acceleration to process signal channels. The controller 300 processes signaling channels to connect requested network adapters 400 to the requesting network adapter 400 in accordance with the user-to-network protocol. The optical bus controller 300 forwards the transmitter and receiver tuning information to the requested network adapter 400. Based on the tuning information, the requested network adapter 400 tunes its receiver to receive data bursts initiated by the requesting network adapter 400. The bus controller 300 also implements the JIT network-to-network protocol to support LAN interconnection.

The optical bus controller 300 can include at least one ingress engine per control channel, at least one egress engine per control channel, an arbitration circuit, electrical to optical (E/O) converters, optical to electrical (O/E) converters, a forwarding data table, and an embedded processor.

JIT protocol messages are received on the signal channel from the optical signal bus 300 and undergo optical to electrical conversion via O/E converters. After the conversion process is completed, the ingress message engines can pass the JIT messages and can take actions based on current state and protocol responses as defined in a finite state machine in accordance with the JIT protocol. Forwarding information is obtained from the forwarding tables. Communication with one or more of the egress engines is achieved via the arbitration logic. Messages that cannot be handled by the ingress engine are passed to the embedded processor for more involved and time intensive decision functions and actions.

The arbitration logic passes messages from the ingress engine to the egress engines based on results of forwarding table lookups. In cases where multiple requests go to the same egress message engine simultaneously, the channel arbitration logic decides which request to serve. In those instances that a requested egress message engine is busy serving another request, the arbitration logic can convey a busy signal to the ingress message engine.

The forwarding table can include information that maps the logical system addresses to the physical ports of the system. This allows arbitrary assignment of system addresses to the physical ports in the system. The forwarding table also is used to direct an optical packet to the right location, information destined to addresses outside those directly connected to the bus. In this regard, the forwarding table may be in communication with a software controller 380 that is outside of the optical bus controller architecture.

As mentioned above, OBS communications may be implemented via a Just-In-Time control protocol. Just in Time refers to all information transfers as bursts. A burst may range from a few nanoseconds to hours or days. JIT makes no assumptions about the time range or information format of a burst. The information within a burst may be analog or digital. No assumption is made about the modulation method or the information density (bit rate or bandwidth), as well.

A request to use a bus can be initiated with a SETUP message sent by the originator of a burst to the optical bus controller 300. The SETUP message can carry parameters related to the connection. These parameters may include a burst descriptor, a Quality of Service (QoS) descriptor, end-to-end connection parameters, a connection reference number, and a wavelength to permit wavelength conversion along the path and interoperability with wireless networks. The optical bus controller 300 consults with delay estimation mechanism based on the destination address and then concurrently returns the updated delay information to the originator by using SETUP ACK message and acknowledges receipt of the SETUP message. The SETUP ACK message also informs the originator of the burst which channel/wavelength to use when sending the data burst.

The originator waits an amount of time based on its knowledge of the round-trip time to the optical bus controller 300, and then sends the burst on its transmit wavelength. Concurrently, the SETUP message can travel across the bus control channel to inform the destination of the burst arrival. If no blocking occurs on the path, the SETUP message will reach the destination node. Upon receipt of the SETUP message, the destination node may choose to send a CONNECT message acknowledging a successful connection.

As noted, JIT signaling is performed out-of-band with the transmitted data being transparent to the intermediate network entities. Thus, no electro-optical conversion is required in the intermediate nodes.

In an exemplary method of OBS transmission via JIT signaling is as follows, a JIT signaling message is sent by a node on the OBS network to set-up the optical path for a subsequent data transmission message. The JIT signaling message is processed by intermediate nodes in the network with electro-optic conversion is performed. Data transmission messages of an arbitrary type are transmitted through the OBS LAN architecture. The arbitrary messages may be analog data transmissions, digital data transmissions, modulations or the like.

As the data transmissions are communicated through the network, electro-optical conversion is unwarranted and no assumptions are made at the nodes, including the intermediate nodes, concerning data rate or modulation methods. However, signaling messages undergo electro-optical conversion and processing by intermediate nodes, such as hubs and passive star couplers (PSCs), as known in the art. Optical communication is conducted such that a high-capacity signaling channel/wavelength(s) is assigned per fiber. The data, aggregated in bursts, can be transferred from one point to the other by setting up the optical path just ahead of the data arrival, i.e., configured by sending a signaling message ahead of the data. Once the data transfer is completed, the connection may be timed out.

JIT signaling utilizes a hierarchical addressing scheme with variable length addresses. Each address field is represented by an address LV (Length, Value) tuple. The length of the address (such as in bytes) is allocated 8 bits, thus allowing 2048 bit address length. The idea of hierarchical addressing presumes that different administrative entities can assign a part of the address hierarchy, with discretion being left to the length and the further hierarchical subdivision of address space. The JIT signaling is contrary to the fixed length addressing schemes, where blocks of addresses are allocated for different entities, thus resulting in less efficient use of address space.

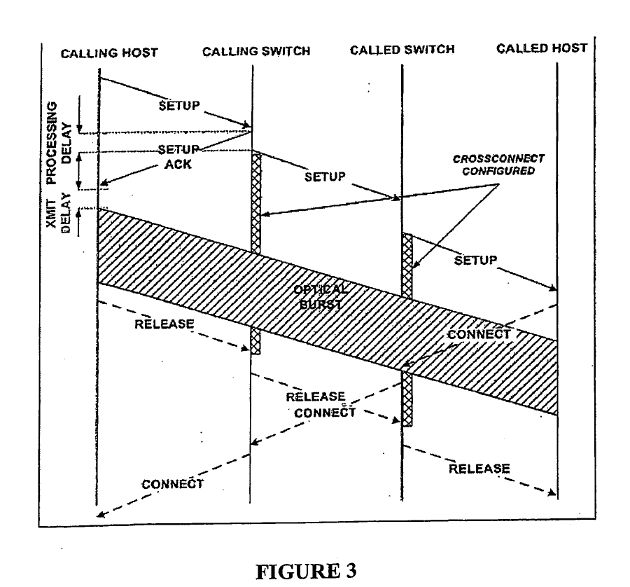

FIG. 3 shows a signaling scheme diagram for JIT signaling implemented in conjunction with an OBS LAN/WAN, in accordance with an embodiment of the present invention. Explicit setup and teardown of the connection is performed. Signaling messages, in the form of SETUP messages sent by the calling host trigger intermediate nodes, such as switches or hub with PSC, to configure the cross-connects for the incoming connection. Additional signaling messages, in the form of RELEASE messages, announce when the cross-connect element is available for a new connection.

A request to use a bus is initiated with a SETUP message being sent by a calling host (such as a network adapter 400) that is scheduled to send out data embedded in a burst to the optical bus controller 300 (such as a hub). The optical bus controller 300 consults with a delay estimation mechanism, such as an ingress engine and address resolution table as discussed earlier, based on the destination address and returns the updated delay information to the calling host by sending a SETUP ACK message. The SETUP ACK message acknowledges receipt of the SETUP message and informs the originating node which channel/wavelength to use when sending the data burst.

The calling host waits an amount of transmission delay time XMT DELAY based on its knowledge of the round-trip time to the optical bus controller, and then sends the optical burst on its transmit wavelength. At the same time, the SETUP message travels across the bus control channel, informing the destination of the burst arrival.

If no blocking occurs on the path, the SETUP message will reach the called host, which then receives the incoming optical burst. The SETUP message carries with it parameters related to the optical burst connection. These parameters include, but are not limited to, a burst descriptor; a Quality of Service (QoS) descriptor having connection bandwidth and priority; the end-to-end connection parameters, including encoding scheme, modulation scheme, and signal type; a connection reference number unique to the calling host; and a designated wavelength to permit wavelength conversion along the path and interoperability with wireless networks.

Upon receipt of the SETUP message, the called host may choose to send a CONNECT message acknowledging the successful completion of the connection. The receipt of the SETUP by the called host indicates that the connection has been established, but does not guarantee its successful completion, since a connection may be preempted somewhere along the path by a higher-priority connection. The OBS LAN may connect to a WAN and support both asynchronous single bursts with a holding time shorter than the diameter of the network and switched optical paths with a holding time longer than the diameter of the network. The architecture provides out-of-band signaling on a separate channel, which undergoes electro-optical conversions at multiple nodes to make signaling information available to multiple intermediate hubs. As no electro-optical conversion takes place at intermediate hubs and no assumptions are made about data rate or signal modulation, the data is transparent to the intermediate network entities. Most message processing is supported at the edge switches, such that the core switches may be kept relatively simple. Even greater simplicity can be achieved by not providing for global time synchronization between nodes, which may require fast clock recovery at the nodes.

A number of input and output ports are provided to the edge and core switches, with each of the ports capable of carrying multiple wavelengths. A separate wavelength on each port may be dedicated to carrying the JIT signaling protocol. A wavelength on an incoming port can be switched to receive either the same wavelength on an outgoing port (no wavelength conversion) or another wavelength on an outgoing port (partial or total wavelength conversion). The switching can be performed by micro-electromechanical systems (MEMS), micro-mirror arrays, SOA, TIR, or the like. Switching time can be maintained in the sub-microsecond range. Thus, after a signaling message informs the intermediate switches of the impending arrival of the burst, the switches can timely reconfigure to channel the data on one of the data wavelengths. The signaling message also can inform the switches of the duration of the burst. Each switch in the network may be configured with a scheduler that tracks wavelength switching configurations and reconfigures the switches in time to allow the data to pass through.

In an alternate embodiment, a method for single optical wavelength transmission and reception is employed on an OBS network that implements JIT signaling protocol. A plurality of network adapters are provided within the OBS network. Each adapter is electronically tuned to generate a unique and dedicated wavelength for optical data transmission to another network adapter configured to receive that wavelength. The optical bus is capable of distributing the unique and dedicated optical signal to multiple network adapters connected to the optical bus. The optical bus controller provides a contention resolution protocol for use of the adapter's receive channel. Since each adapter has a unique transmit wavelength, multiple adapters in the network can simultaneously transmit over the optical bus without contention, provided that each transmitter seeks a unique destination. As an alternative to electronically tuning the transmitting network adapter to transmit the unique and dedicated wavelength, the receiving network adapter may also be electronically tuned to the unique and dedicated wavelength.

In one non-limiting embodiment, the JIT protocol is used as an optical bus interconnect protocol in conjunction with the OBS LAN, to thereby more available memory bandwidth than that of conventional bus architecture. Additionally, the JIT signaling protocol makes greater amounts of memory available to different applications as local memory and provides a more seamless merge of LAN/WAN and Storage Area Networking (SAN) applications.

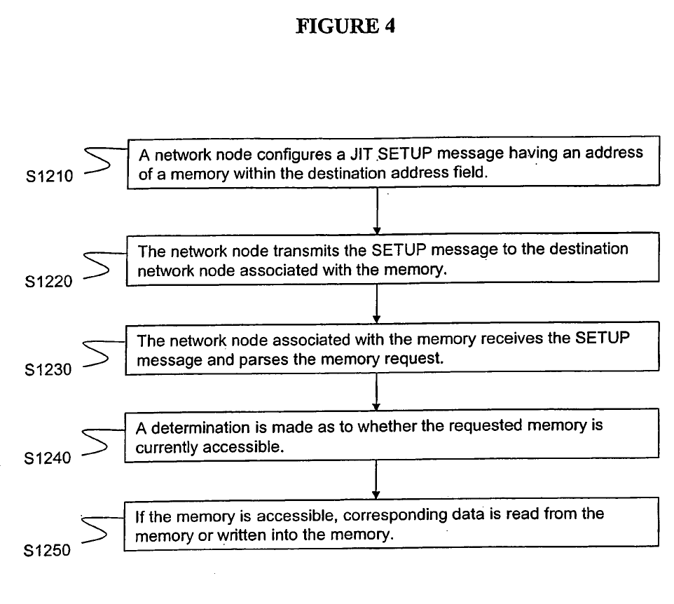

In another non-limiting embodiment, a method for memory access in an OBS network implementing JIT signaling is illustrated in FIG. 4. At step 1200, an optical burst switch network that implements just-in-time signaling protocol is provided. At step 1210, a network node configures a JIT signaling protocol setup message that includes an address of a memory location within the destination address field. At step 1220, the network node transmits the setup message to the destination network node associated with the memory. At step 1230, the network node associated with the memory receives the setup message, and parses the memory request. At step 1240, a determination is made whether the requested memory is currently accessible. At step 1250, if the memory is accessible, corresponding data is read from the memory or written into the memory.

The current JIT protocol has an address field up to 2048 bits, which will be able to support access to individual bytes inside these nodes. In one embodiment, DRAMS are arranged in banks and a memory request can be accepted only if the corresponding bank is free. Therefore, for a 1 GB memory chip consisting of 4 banks, the destination address doesn't need to contain the 30-bits of the byte-level address. It only needs to specify the bank it needs access to, which can be done using only 2 bits.

FIG. 5B depicts a block diagram of another embodiment of an optical bus switch network implementing JIT signaling. The optical bus controller 300 is in signaling channel communication with a plurality of memory nodes implementing network adapters 400. Additionally, the star coupler 210 is in data channel communication with the plurality of network adapters 400 (not shown). The network adaptors 400 for the memory nodes may be in communication with large amounts of memory. For example, the bus adaptor nodes can consist of large arrays of conventional memory (e.g. DDR DRAMS) serving some or all the network nodes in the LAN. The destination address field corresponding to the memory nodes (e.g., bus adaptor nodes) includes the address of the memory location that is being referenced. Other nodes can be network adapter nodes that access the memory location. The network adapter nodes that send signaling messages, such as SETUP, to the memory nodes to access the memory.

The exemplary JIT protocol has an address field up to 2048 bits, which will be able to support access to individual bytes of the memory nodes. In one embodiment, DRAMS are arranged in banks and a memory request can be accepted only if the corresponding bank is free. Therefore, for a 1 GB memory chip consisting of 4 banks, the destination address doesn't need to contain the 30-bits of the byte-level address. It only needs to specify the bank it needs to access, which can be achieved using only 2 bits. The controllers for memory nodes parse the SETUP message, and depending on whether the bank requested is busy or not, determine whether the request is denied or accepted. If the request is accepted, the bank is marked busy until the corresponding data is read or written. In other words, the memory banks work in exactly the same fashion as other nodes in the network.

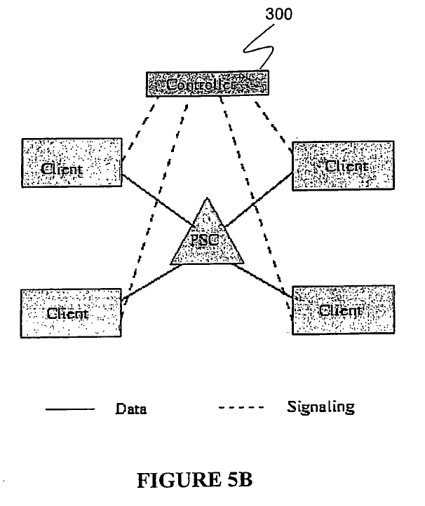

FIG. 6A depicts a flow diagram according to one embodiment of the present invention for optical burst switching. Signaling messages (e.g., SETUP) can enter an optical burst switching device and after entry are interpreted by a parser, which determines the desired destination. The desired destination is used to select one of potentially several forwarding tables which can identify the appropriate output port designation. Output port information from this lookup, in combination with the source port information taken from the parser, and any relevant timing information from the SETUP message can be used to write the crosspoint schedule memory. This memory is asynchronously accessed by the switching device controller to determine when to close and open various crosspoints within the switching device. Signals from the controller to the crosspoints effect their opening and closure in accordance with this schedule information.

FIG. 6B depicts one exemplary hardware implementation according to the invention for implementing the flow diagram process of FIG. 6A. As shown in FIG. 6B, a JIT controller is in communication with a register address block (RAB) for storage of system state. Optical data entering the optical switching device can arrive in a medium access control (MAC) format recognized by the message parser which, as part of the ingress engine, can derive from the incoming optical data the above-noted desired destination information. The message preprocessing unit can be used to examine for example lookup tables (i.e., forwarding tables) or perform routing algorithm calculations to determine to which output port that the incoming optical data is to be routed. The message processor and scheduler will look at the derived output port information and other information such as the length of duration of the incoming optical data and the scheduling protocol (e.g., JIT, JET, and Horizon) to establish when to set up with the above noted switch crosspoint controller the closing and opening times of the optical switching devices. State Machine Module (SMM) architecture as known in the art can be utilized by the message processor and scheduler. The message processor and scheduler as shown in FIG. 6B can generate signals to be output to the network for downstream node routing control (e.g., network information).

Further, as shown in FIG. 6B, the message processor and scheduler can utilize an optical cross connect hash connection table providing to the message processor and scheduler for example a listing of the current and potential switch states in an optical switching network. The message processor and scheduler provide on schedule information to for example semiconductor optical amplifier switches for configuration of these optical switching devices. Other optical switching devices could be used in the present invention depending on the response time required for various optical switching applications. Those switching devices can include but are not limited to micro-electro-mechanical systems switches, microfluidic bubble switches, thermo-optic switches, and liquid crystal switches.

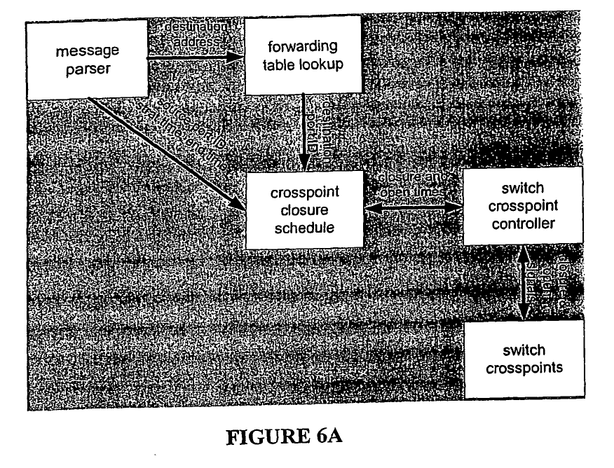

In another embodiment of the invention, a method for unified global addressing in an OBS LAN implementing JIT signaling processing is described by the flow diagram of FIG. 7. At step 1300, a first administrative entity assigns a first address tuple (e.g., a record) of discretionary length to an optical signal. At step 1310, a second administrative entity assigns a second address tuple of discretionary length. At step 1320, this process continues at all administrative entities until a hierarchical address is assigned to the optical signaling message. The length of the address is allocated 8 bits, thus allowing for a maximum of a 2048 bit address length. This method is contrary to the fixed length addressing schemes, where blocks of addresses must be allocated for different entities thus resulting in inefficient use of address space.

In another embodiment of the invention, the optical burst bus is used as a LAN and the network adapters take on the role of conventional network interface cards, connecting to the internal bus of a client or server computer. Device drivers in the terminal host's operating system provide linkage between legacy network protocols such as TCP/IP and the Network adapter. Alternative protocol stacks may also be supported, such as Fiberchannel, or the newly emerging Transport layer protocols, defined for JIT networks.

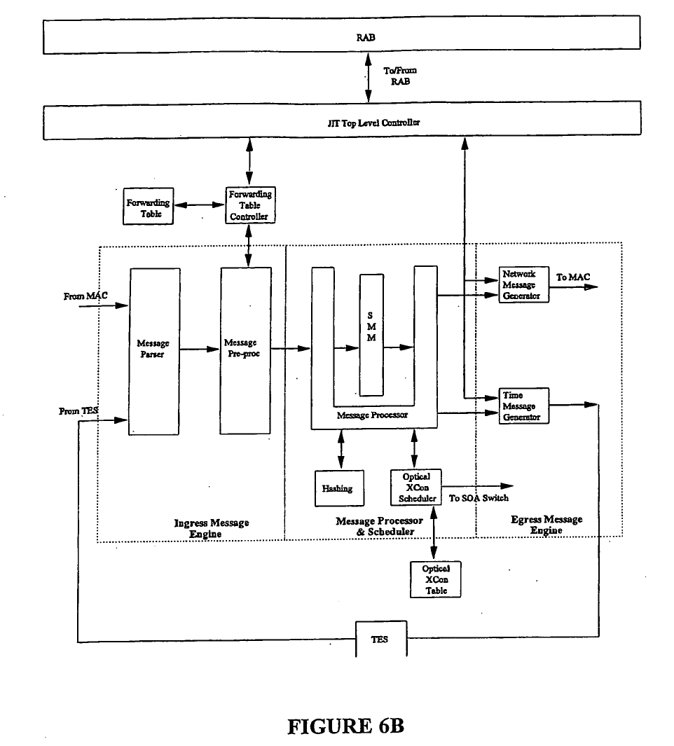

FIG. 8 is an exemplary optical network adapter using the JIT, JET or Horizon protocols. As shown, the network adapter can include a PCI bus, an arrayed-waveguide grating, a transmit laser tuned to a specific wavelength, a PHY chip, an FPGA, a receive array and various memory elements. The PCI bus is used as the internal communications path within the client PC. The transmit laser is used to send data signals to the LAN switch. The PHY chip uses the MAC protocol to convert the received optical signals into a bitstream. The AWG is used to demultiplex the received optical signals so that each element of the receiver array senses only a single wavelength. The memory elements are used for buffering information. The FPGA encodes the state machine logic associated with executing the JIT, JET or Horizon protocols. Not shown are devices (such as a transceiver) used for sending and receiving signaling information to the optical switch controller.

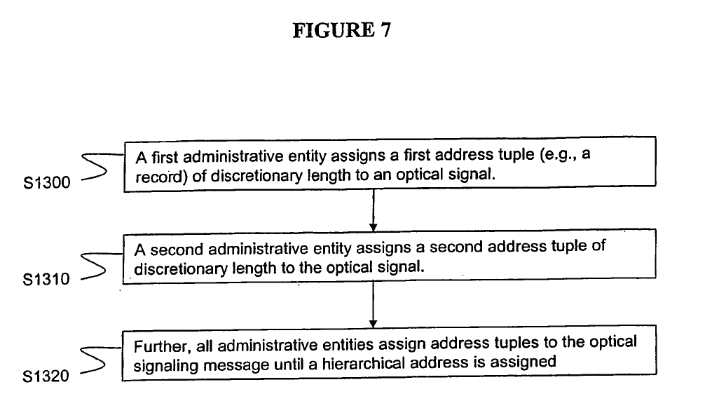

FIG. 9 is an exemplary optical bus (or switch) signal controller using the JIT, JET or Horizon protocols. As shown, the controller can includes a PCI bus, an array of transceivers tuned to the specific wavelength used for signaling, a PHY chip, an FPGA, a receive array and various memory elements. The PCI bus is used as the communications path to an embedded computer, used to handle failure modes in the protocol. The PHY chip uses the MAC protocol to convert the received optical signals into a bitstream. The memory elements are used for buffering information. The FPGA encodes the state machine logic associated with executing the JIT, JET or Horizon protocols. The cross connect control interface is used to drive switch devices such as optical MEMS switch arrays.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended Claims. Although specific terms are employed herein, they are used in a generic and descriptive sense only and not for purposes of limitation.

1. A scheduling device for an optical burst switch network, comprising:
a plurality of schedulers each corresponding to a respective channel in the optical burst switch network and configured to maintain a transmission schedule for the respective channel; and
a controller configured to receive a burst transmission request and to select at least one of the schedulers as a selected scheduler to schedule a burst transmission.

2. The device of claim 1, wherein the controller is configured to pass the burst transmission request to the plurality of schedulers.

3. The device of claim 2, wherein:
each scheduler is configured to search its transmission schedule and to report to the controller vacant transmission slots in response to the burst transmission request, and
the controller is configured to instruct the selected scheduler to schedule the burst transmission based on the reported vacant transmission slots.

4. A scheduling method of managing transmissions of a data burst in an optical burst switch network having a plurality of channels, the method comprising:
receiving a burst request;
generating an inquiry to a plurality of schedulers corresponding to said respective channels, each scheduler configured to maintain a transmission schedule for the respective channel;
searching the transmission schedules at each of the schedulers to determine vacant slots for each channel; and
selecting at least one of the plurality of schedulers to schedule the burst based at least in part on the reported vacant transmission slots.

5. The method of claim 4, wherein the selecting comprises:
determining a wavelength conversion capacity for each of the schedulers in the channels; and
selecting one of the schedulers based at least in part on determined respective wavelength conversion capacities.

6. The method of claim 4, wherein the selecting comprises:
utilizing a predetermined criterion to determine the selected scheduler.

7. The method of claim 6, comprising:
selecting a channel with the lowest starting void SV or ending void EV.

8. An Optical Burst Switch (OBS) network comprising:
an optical bus;
network terminal devices coupled to the optical bus;
a plurality of network adapters in optical communication with the optical bus and in communication with the network terminal devices, each of the network adapters configured to provide bi-directional transmission of burst transmissions between the optical bus and the network terminal devices; and
an optical bus controller in optical communication with the optical bus and configured to establish signal communications between at least two of the network adapters based on a request initiated by one of the at least two of the network adapters.

9. The network of claim 8, wherein the network adapters each include a tunable receiver, a transmitter, and control logic for bi-directional transmission of burst transmissions.

10. The network of claim 8, wherein the optical bus includes a passive star coupler having plural connection ports respectively connected to the network adapters.

11. The network of claim 8, wherein the optical burst controller comprises a part of a local area network (LAN).

12. The network of claim 8, wherein the network adapters comprise optical network interfaces in network communication with one or more external networks.

13. An optical signal bus for use in an Optical Burst Switch (OBS) network, comprising:
a plurality of optical filters each including an input configured to receive an optical signal, a first output configured to transmit a control channel signal to an optical bus controller, and a second output configured to transmit a data signal on an individual wavelength range;
a signal coupling device including,
a plurality of inputs in optical communication with the second output of each of the plurality of optical filters, and
a plurality of outputs configured to transmit in respective wavelength ranges a combined data signal from the plurality of inputs; and
a plurality of optical couplers each including:
a first input configured to receive the control channel signal initiated by the optical bus controller,
a second input configured to receive the combined data signal from the signal coupling device, and
an output configured to transmit an output optical signal.

14. The bus of claim 13, wherein the signal coupling device comprises a passive star coupler having plural connection ports respectively connecting said plurality of inputs to said plurality of outputs.

15. An optical bus network adapter for use in an Optical Burst Switch (OBS) network, comprising:
an optical filter including,
an input configured to receive an inputted optical signal,
a first output configured to output a data signal, and
a second output configured to transmit a control signal;
a data channel receiver including an input configured to receive the data signal from the optical filter and an output configured to transmit the data signal;
a control channel receiver including an input configured to receive the control signal from the optical filter and an output configured to transmit the data signal;
a physical layer interface including,
a first input configured to receive the control signal from the control channel receiver,
a second input configured to receive the data signal from the data channel receiver,
a first output configured to transmit the control signal, and
a second output configured to transmit the data signal;
a control message processor including a first input configured to receive the control signal from the physical layer interface and an output configured to transmit a control message, the control message processor being in communication with an adapter control processor and a buffer memory and configured to determine at least one control criterion; and
a backplane interface including,
a first input configured to receive the data signal from the physical layer interface,
a second input configured to receive the control message from the control message processor, and
an output configured to transmit a signal including the data signal and the control message.

16. An optical bus controller implemented in an Optical Burst Switch (OBS) network, comprising:
a plurality of optical-to-electrical converters each including an input configured to receive an optical signal and an output configured to transmit an electrical signal;
a plurality of ingress message engines each including an input configured to receive the output of one of the optical-to-electrical converters, to parse the output of the one of the optical-to-electrical converters, and to obtain current state and protocol responses;
an address resolution table configured to communicate with the plurality of ingress message engines to provide the ingress message engines with forwarding information;
a channel arbitration device configured to communicate with the plurality of ingress engines and to determine a forwarding schedule based on inputs from the ingress engines and the address resolution table;
a plurality of egress message engines each including an input configured to receive communication from the channel arbitration device and an output configured to transmit scheduling data; and
a plurality of electrical-to-optical converters each including an input configured to receive the scheduling data from the egress engines and an output configured to transmit the scheduling data to the optical signal bus.

17. An Optical Burst Switch (OBS) network, comprising:
an optical signal bus including a signal coupling device;
a plurality of network adapters in optical communication with the optical signal bus and in network communication with network terminal devices, wherein each of the network adapters is coupled to one of respective client terminals and includes a tunable receiver, a transmitter, and a control device so as to perform bi-directional movement of data signals as bursts between the client terminal and the OBS network system; and
an optical bus controller in optical communication with the optical signal bus and configured to process signals from the optical signal bus to establish communications between a requested network adapter and a requesting network adapter based on a predetermined communication protocol, said optical bus controller configured to implement a just-in-time signaling protocol to signal one of the network adapters coupled to the network to indicate that burst communications are forthcoming.

18. The system of claim 17, wherein the signal coupling device comprises a passive star coupler having plural connection ports respectively connecting said network adapters to said network terminal devices.

19. The system of claim 17, wherein the optical bus controller comprises a part of a local area network (LAN).

20. A method for transparent data transmission in an optical network including a plurality of nodes, comprising:
providing an optically inclusive network configured to schedule optical burst switching of data bursts;
transmitting a signaling message from a node to set-up an optical path for a subsequent data transmission message;
performing electro-optic conversion of the signaling message;
processing the converted signaling message at one node in the network.

21. The method of claim 20, further comprising:
implementing Just-in-Time (JIT) protocol in the network.

22. A method for single wavelength data transmission in a network, the method comprising the steps of:
providing an optical burst switch network configured to schedule optical burst switching of data bursts;
providing a plurality of network adapters within the optical burst switch network, each of the plurality of network adapters having respective wavelengths for optical data transmission;
transmitting data from one of the plurality of network adapters on the respective wavelengths associated with the one of the network adapter; and
electronically tuning the one of the plurality of network adapters to transmit a wavelength of another network adapter for receiving data transmissions.

23. The method of claim 23, further comprising:
implementing Just-in-Time (JIT) protocol in the optical burst switch network.

24. A method for memory access in an optical burst switch network including a plurality of network nodes, comprising:
providing an optical burst switch network configured to schedule optical burst switching of data bursts;
generating, at one of the network nodes, a setup message that identifies a memory within a destination address field;
transmitting, from the one of the network nodes, the setup message to another network node associated with the memory;
receiving the setup message at the another network node associated with the memory and parsing the setup message;
determining whether the memory identified by the setup message is currently accessible; and
accessing the memory in response to a result of the determining step indicating that the memory is accessible.

25. The method of claim 24, further comprising:
implementing Just-in-Time (JIT protocol in the optical burst switch network.

26. A method for hierarchical addressing in an optical burst switch network, comprising:
assigning, at a first administrative entity, a first address record of a discretionary length; and
assigning, at an (n+1)th administrative entity, an nth address record of a discretionary length.

27. The method of claim 26, wherein the optical burst switch network implements a just-in-time signaling protocol.
